(19) United States
(12) Patent Application Publication
(10) Pub. No.: US 2024/0269549 A1
(43) Pub. Date: Aug. 15, 2024

(54) SYSTEMS AND METHODS FOR MEASURING INPUT LATENCY FOR CLOUD GAMING APPLICATIONS

(71) Applicant: Meta Plarforms, Inc., Menlo Park, CA (US)

(72) Inventors: Xiaoming Wang, Kirkland, WA (US); Naizhi Li, Redmond, WA (US); Puttaswamy Rahul Gowda, Berkeley, CA (US); Qunshu Zhang, Sammamish, WA (US); Serge-Olivier Amega, Seattle, WA (US)

(21) Appl. No.: 17/508,293

(22) Filed: Oct. 22, 2021

Related U.S. Application Data
(60) Provisional application No. 63/194,821, filed on May 28, 2021.
(60) Provisional application No. 63/105,320, filed on Oct. 25, 2020.

(51) Int. Cl. A63F 13/355; A63F 13/40

(52) U.S. Cl. CPC A63F 13/355; A63F 13/40

(57) ABSTRACT

The disclosed computer-implemented method may include (i) sending, to a cloud gaming server, cloud gaming input information with an input creation timestamp that marks when the cloud gaming input information was created, (ii) receiving, in response to sending the cloud gaming input information, a frame creation timestamp that marks when a frame was drawn for a virtual display at the cloud gaming server, (iii) storing the frame creation timestamp in memory, (iv) creating a frame render timestamp that marks a timing of an intercepted client-side video frame render event of translating the frame to draw a corresponding frame for a display at a cloud gaming client device, and (v) automatically providing feedback to improve a cloud gaming experience. Various other methods, systems, and computer-readable media are also disclosed.

### CROSS-REFERENCE TO RELATED APPLICATIONS

This application claims the benefit of U.S. Provisional Application No. 63/105,320, filed 25 Oct. 2020, and U.S. Provisional Application No. 63/194,821, filed 28 May 2021, the disclosures of each of which are incorporated, in their entirety, by this reference. Co-pending U.S. application Ser. No. 17/506,640, filed 20 Oct. 2021, is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a flow diagram of an example method for measuring input latency for cloud gaming applications.

FIG. 2 is a block diagram of an example system for measuring input latency for cloud gaming applications.

FIG. 3 is a block diagram of another example system for measuring input latency for cloud gaming applications.

FIG. 4 is a diagram of an example network message for transmitting an input creation timestamp.

FIG. 5 is a diagram of a graphical user interface for a cloud gaming application.

FIG. 6 is a diagram of another graphical user interface for a cloud gaming application and a corresponding network message.

FIG. 7 is a diagram indicating a matching between an input creation timestamp and a frame creation timestamp.

FIG. 8 is a diagram of an example network message for transmitting an association between an input creation timestamp and a frame creation timestamp.

FIG. 9 is a timing diagram of a more comprehensive example of a method for measuring input latency for cloud gaming.

FIG. 10 is a flow diagram of an example method for measuring input latency for cloud gaming applications.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Cloud gaming may refer to an innovative form of computer gaming where a substantial portion of video is rendered at a remote server and beamed back to a client gaming device rather than being created directly on the client gaming device itself. Cloud gaming may have substantial benefits over traditional client-side gaming technologies. In particular, cloud gaming may open up new demographics and populations of players who might otherwise not have ready access to higher end computer hardware. Instead, a larger multimedia conglomerate may optionally leverage its own data center server farms to render high-definition video for players on their client gaming devices. These gaming devices may be substantially lower powered and more affordable (e.g., a relatively inexpensive smartphone) with the processing power to download and replay high-definition video rather than directly creating the video itself. Indeed, such lower powered and more affordable devices may be unable to directly render the video themselves fast enough to enable the corresponding game playing experience.

Although cloud gaming provides a number of potential advantages over more traditional systems, cloud gaming can also introduce new challenges and complexities. For example, although cloud gaming can diminish a need or desire for higher end client-side computing hardware and processing power, cloud gaming nevertheless can require a highly reliable and high-bandwidth network connection (e.g., depending on the response times corresponding to a particular game design). Similarly, the distance between the client and the server can create a de facto barrier that can hinder or delay an ability of the server to analyze the game playing experience at the client.

Moreover, certain cloud game designers, publishers, or administrators may form agreements with a larger multimedia conglomerate to provide access to cloud games through a larger social network or multimedia service. The larger multimedia conglomerate may also have access to larger data center server farms than the cloud game designers would otherwise have ready access to. For example, a particular cloud game designer may provide access to its cloud game through a social network. In these cases, it can be desirable for the multimedia conglomerate to perform big data operations to evaluate the game playing experience that the game designer is providing, thereby helping to ensure that the common users between the game designer and the multimedia company are having a satisfactory experience.

As one illustrative example, in the context of cloud gaming it can be helpful to evaluate the quality of latency associated with the cloud gaming experience. A variety of different latency metrics may be useful for monitoring and adjusting a configuration for enabling and playing one or more cloud games.

To be even more precise, such metrics may include measurements of latency between specific events within an overall cloud gaming processing pipeline, including more common or useful events such as creation of input information as a user applies one or more inputs to a cloud gaming client device, a frame creation event at which point a frame, which was triggered by such user input, is actually generated or rendered at the cloud gaming server, and/or a frame render event at which point the original frame, which was drawn for a virtual display at the server, may be translated to draw a corresponding frame for a display at the client (e.g., a physical display). The specific latency between the creation of the user input and the frame render event on the cloud gaming client device may be useful to measure, and this application discloses an innovative methodology for capturing and reporting this measurement.

Moreover, the technology of this application does not merely measure end-to-end latency between client-side input and client-side rendering, in a conventional manner, but more importantly may perform this measurement in an innovative manner that enables a much larger scale of usage across a much wider and more diverse set of applications. Generally speaking, the methodology of this application may be application or cloud game agnostic in the sense that the methodology may apply, in a uniform or substantially uniform manner, to a wide variety of cloud games. Moreover, the methodology of this application may be applied in a manner that is abstracted away from one or more layers of implementation details regarding how each specific cloud game actually receives, parses, and/or processes one or more items of input instruction information from a user playing a cloud game. Thus, rather than the cloud game itself, and rather than a particular platform on which the cloud game is being played, directly accessing a full programming or operating system stack, and making accommodations for differences between different platforms with different underlying implementation details, the methodology of this application may instead apply at a higher level of abstraction in a substantially uniform manner across a large number of cloud gaming applications and/or corresponding platforms with a wide variety of implementation details.

To achieve these benefits, for example, one or more modules may intercept a client-side user input instruction event, a client-side render or display event, and/or a server-side frame creation event. Thus, rather than having internal access to a client-side cloud game application itself and/or a server-side frame creation rendering engine or application, and rather than accommodating various differing implementation details that these applications may have between cloud games and between platforms, one or more of these modules may instead reside external to these applications, with a layer of abstraction between them, and instead simply monitor for when the applications output data indicating a client-side user input instruction event, a client-side frame render or display event, and/or a server-side frame creation event, for example. By simply monitoring, from an external position, when one or more of these events occur, the modules that perform this monitoring and interception may bypass a request or need to fully understand various implementation details for how these applications/platforms actually generated these events, as discussed in more detail below.

Features from any of the embodiments described herein may be used in combination with one another in accordance with the general principles described herein. These and other embodiments, features, and advantages will be more fully understood upon reading the following detailed description in conjunction with the accompanying drawings and claims.

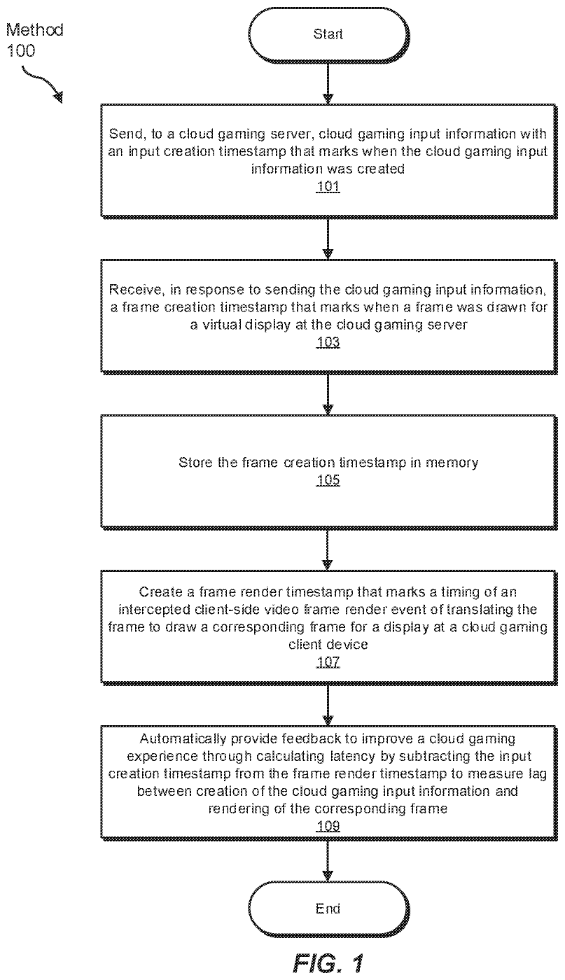

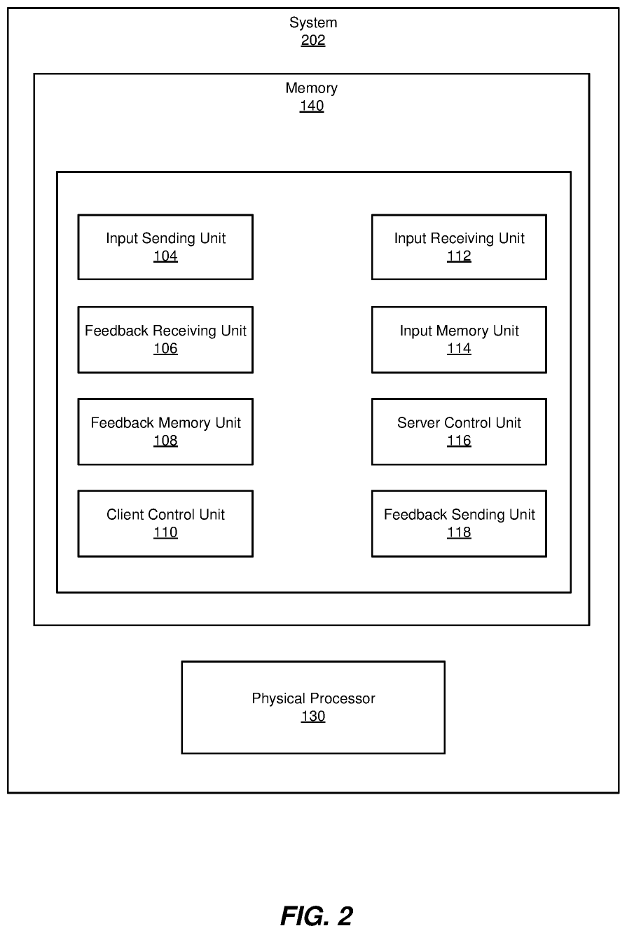

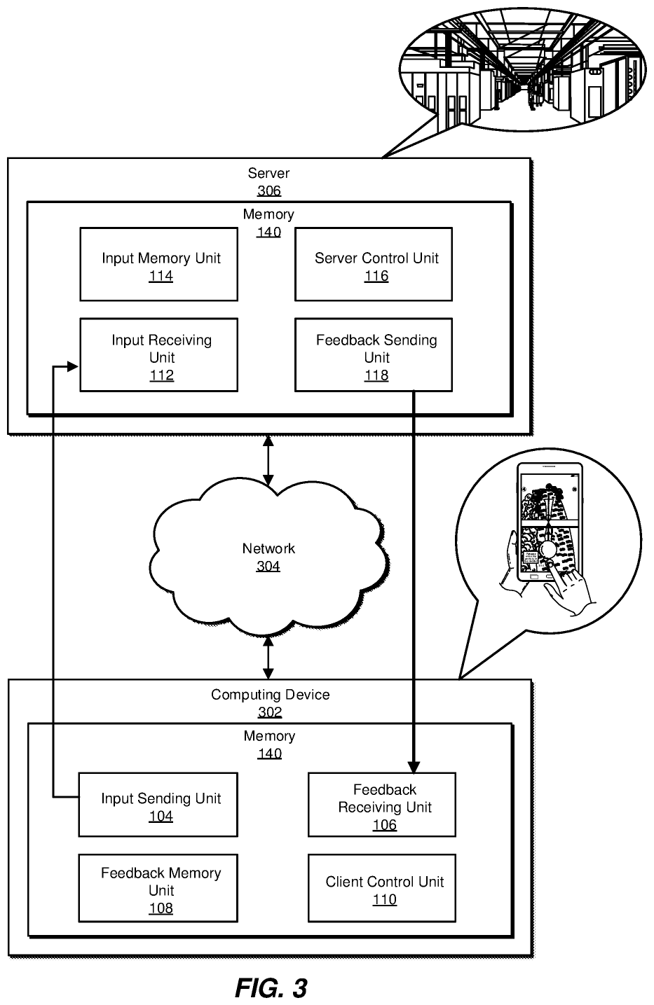

The following will provide, with reference to FIGS. 1-10, detailed descriptions of systems and methods for measuring input latency for cloud gaming applications. For example, FIG. 1 is a flow diagram of an example computer-implemented method 100 for measuring input latency for cloud gaming applications The steps shown in FIG. 1 may be performed by any suitable computer-executable code and/or computing system, including the system(s) illustrated in FIGS. 2-3. In one example, each of the steps shown in FIG. 1 may represent an algorithm whose structure includes and/or is represented by multiple sub-steps, examples of which will be provided in greater detail below.

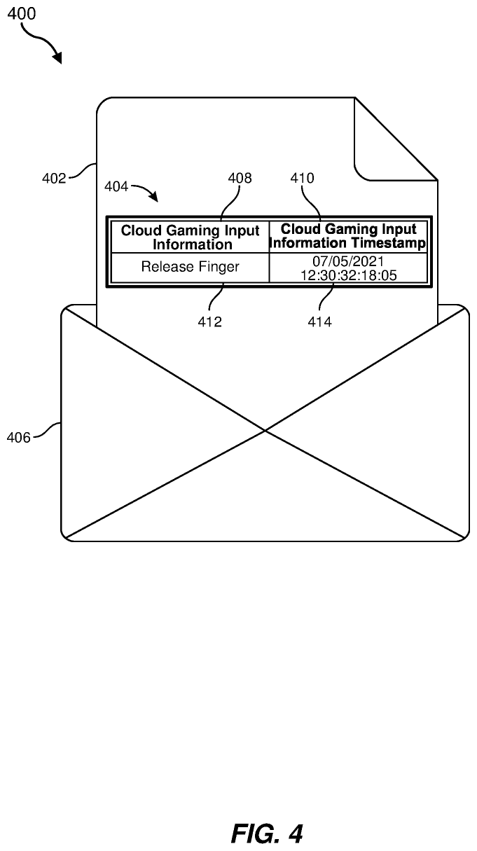

As illustrated in FIG. 1, at step 101 one or more of the systems described herein may send, to a cloud gaming server, cloud gaming input information with an input creation timestamp that marks when the cloud gaming input information was created. For example, an input sending unit 104 within a computing device 302, which may correspond to a cloud gaming client device, may, at step 101, send to a cloud gaming server, which may correspond to a server 306 shown in FIG. 3, cloud gaming input information (as discussed further in connection with FIG. 4) with an input creation timestamp that marks when the cloud gaming input information was created. FIG. 2 similarly shows a system 202 with corresponding units, as discussed in more detail below.

The systems described herein may perform step 101 in a variety of ways. In one example, input sending unit 104 may perform step 101 at least in part by monitoring for, detecting, and/or intercepting data indicating the creation of the cloud gaming input information. In particular, input sending unit 104 may perform step 101 as a unit that is disposed external to a cloud game application or process that generates the cloud gaming input information in response to manual or other input from a human user at a cloud gaming client device.

As one illustrative example, input sending unit 104 may be disposed directly within a corresponding cloud gaming application. In other words, in these examples, the cloud gaming application itself may have been configured or programmed to perform the functions of input sending unit 104 (e.g., by directly disposing or hooking input sending unit 104 within the cloud gaming application). This configuration may have been established as part of a prearranged agreement with the cloud gaming vendor or marketplace administrator, etc., to facilitate the performance of method 100 including the beneficial measurement of end-to-end latency, as discussed in more detail below. Furthermore, in these examples, input sending unit 104 may optionally transmit the cloud gaming input information in-band as part of regular, normal, or in-game network transmissions between the cloud gaming client device and the cloud gaming server (e.g., regular network transmissions exchanging server-side rendered video in response to client-side user input instructions).

Additionally, or alternatively, in other examples input sending unit 104 may be disposed within an external application, hypervisor, process, gaming console application or server, emulator, meta-application, general-purpose social network application or website (e.g., a cloud game non-specific social network that enables access to a multitude of different cloud games), or operating system, rather than being disposed directly within the cloud gaming application itself. In such examples, input sending unit 104 may optionally perform step 101 in a manner that is entirely or substantially cloud game agnostic. The term cloud game agnostic may refer to the performance of method 100 being substantially or entirely the same regardless of dramatic differences in implementation details between different cloud game applications regarding how they internally generate, parse, and/or process input or output information, for example. Thus, from an external position, input sending unit 104 may monitor the performance of a wide variety of different cloud games, with dramatically different internal configurations, within the same larger application (e.g., a general-purpose social network application) and simply detect attempted network packet transmissions to perform method 100 in the same or substantially the same manner regardless of which cloud game is actually executing. In summary, the cloud gaming application may optionally execute within the larger external application, even if input sending unit 104 is not actually part of the cloud gaming application itself. From this position, input sending unit 104 may monitor for network messages or items of output that the cloud gaming application is attempting to transmit to the cloud gaming server.

Upon detecting or intercepting such an attempt to upload an instance of user input across a wide area network to a remote cloud gaming server, input sending unit 104 may, in these examples, inspect, analyze, and/or parse the attempted network message. For example, input sending unit 104 may optionally identify, locate, and/or extract one or more items of information indicating the corresponding user input. Such information may identify the particular buttons pressed by a user or the particular manner and/or timing by which the user manipulated one or more buttons, screens, or user interfaces. Additionally, or alternatively, input sending unit 104 may extract or otherwise identify a timestamp that matches the corresponding user input such that the timestamp indicates the particular time at which the user input information was created in response to the actual manual input by the user. In further examples, rather than input sending unit 104 proactively extracting or generating this information itself, input sending unit 104 may simply receive the user input information and/or the corresponding timestamp from another unit or component that is configured to relay or forward this information to input sending unit 104. In either case, input sending unit 104 may optionally, in these examples, transmit the cloud gaming input information out-of-band such that the cloud gaming input information is transmitted in a channel (e.g., separate connection, separately established network path, etc.) that is separate from the network channel for regular or normal communications between the client and server for enabling the cloud gaming experience (e.g., the regular channel exchanging server-side rendered video in response to client-side entry of user input by a player of a corresponding cloud game).

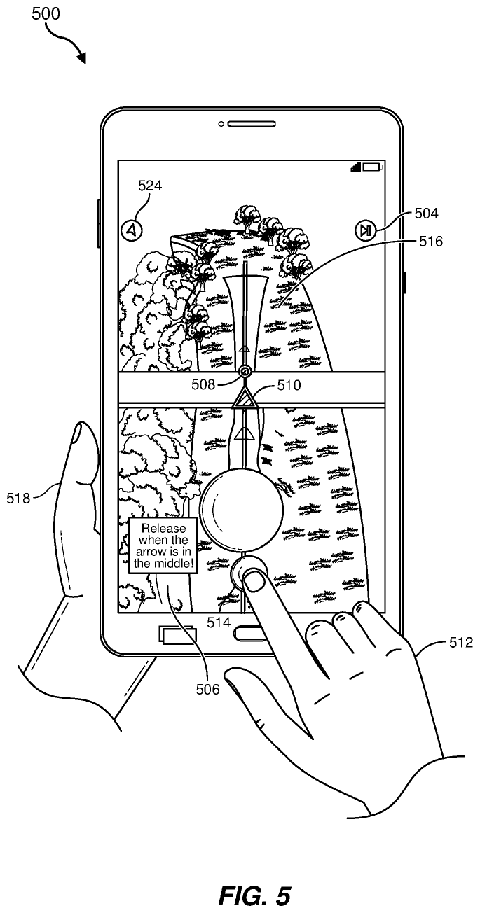

FIG. 4 shows an illustrative diagram 400 of a network message 402 within a packet or encapsulation 406, wherein network message 402 includes an item of cloud gaming input information. In particular, the item of cloud gaming input information may include a table 404 that further includes a single row along a column 408 and column 410. As further shown in this diagram, the single row of the table underneath column 408 may include an item 412 of cloud gaming input information. In the illustrative example of this figure, item 412 may more specifically indicate manual user input corresponding to the release of the finger upon a touchscreen display, such as a touchscreen display on a smartphone or tablet, as discussed more in connection with FIG. 5 below. Moreover, table 404 also further includes an item 414 of a cloud gaming input information timestamp, which further specifies, with some precision, a date and/or time of day of the corresponding user input whereby the user released a finger upon the touchscreen. The information indicating the time of day may be precise to the hour, minute, second, centi-second, millisecond, or beyond to an arbitrary level of precision consistent with the performance of method 100 across a high-bandwidth or other wide area network connection to generate a corresponding cloud gaming experience. Thus, FIG. 4 provides a diagram of the particular type of cloud gaming input information that may be transmitted by input sending unit 104 to the cloud gaming server at step 101.

Similarly, FIG. 5 shows an illustrative diagram 500 of an example graphical user interface for a corresponding cloud game that a user may be playing in a manner that triggers input sending unit 104 to transmit the cloud gaming input information at step 101. Diagram 500 further shows that a hand 518 and a hand 512 of the user may manipulate a smartphone, which may be displaying the graphical user interface that includes a compass icon 524, a play/pause button 504, and/or a user prompt 506, which may prompt the user to release a button of the graphical user interface when the arrow 510 is at a middle point 508 of the central axis of the graphical user interface. Thus, the graphical user interface may correspond to a golf-themed cloud game that tests the ability of the user to only trigger the swing of the golf ball at a precise centralized location that aligns with a corresponding flag or hole of a golf course 516 shown on the screen of the smartphone. When the user releases the finger from a corresponding button 514 to trigger the release of the golf ball, this may correspond to user input that is recorded and transmitted as part of the cloud gaming input information at step 101 and further illustrated in connection with FIG. 4, as discussed above.

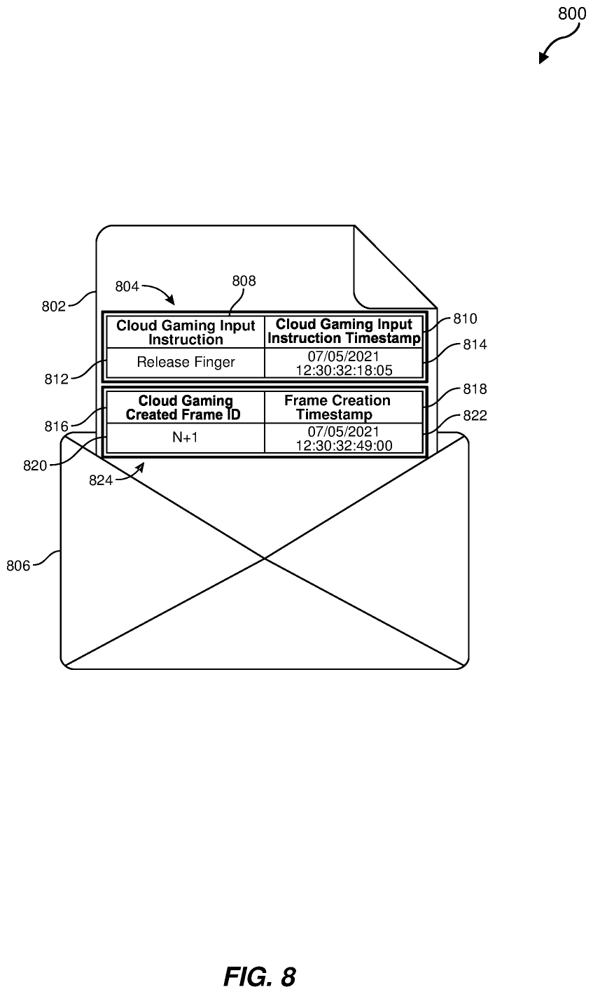

As illustrated in FIG. 1, at step 103 one or more of the systems described herein may receive, in response to sending the cloud gaming input information, a frame creation timestamp that marks when a frame was drawn for a virtual display at the cloud gaming server. For example, feedback receiving unit 106 may receive, at step 103, and in response to input sending unit 104 sending the cloud gaming input information to server 306, a frame creation timestamp (e.g., such as the frame creation timestamp shown in FIG. 8) that marks when a frame was drawn for a virtual display at the cloud gaming server.

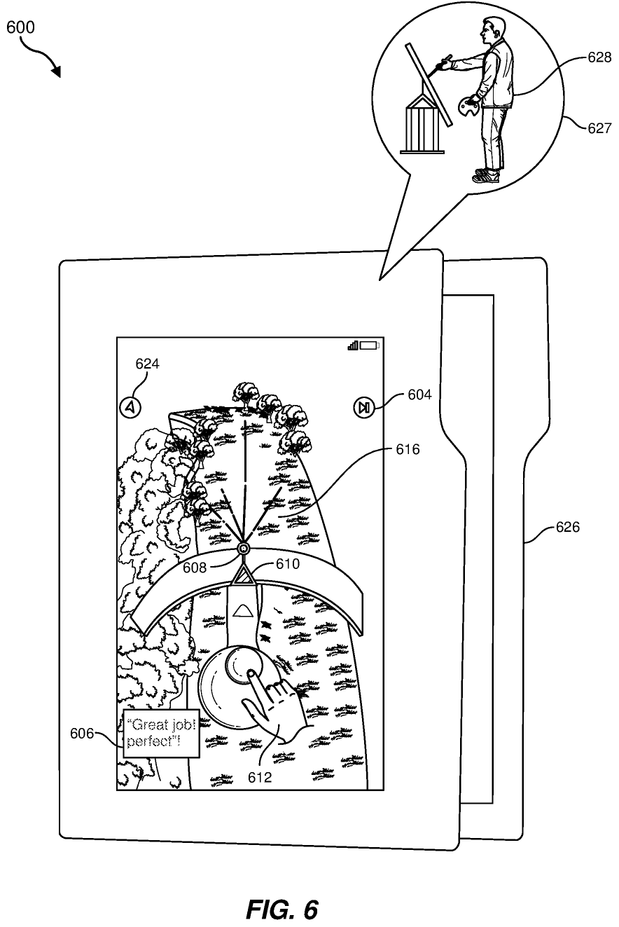

Feedback receiving unit 106 may receive the frame creation timestamp in a variety of ways. For example, prior to feedback receiving unit 106 actually receiving the frame creation timestamp, method 100 may further optionally involve the cloud gaming server generating a feedback message that includes the frame creation timestamp for transmission as a reply to the cloud gaming input information. FIGS. 6-9 help to illustrate the steps performed at the cloud gaming server to generate the feedback message in coordination with the cloud gaming client device to facilitate the performance of method 100. In the context of the steps performed by the cloud gaming server, the server may therefore include multiple separate modules, including an input receiving unit 112, an input memory unit 114, a server control unit 116, and a feedback sending unit 118, which are discussed in more detail below in connection with FIGS. 6-9.

Beginning with FIG. 6, this figure may show another diagram 600 of an image for the graphical user interface discussed above in connection with FIG. 5. In this figure, rather than being displayed within a touchscreen of a smartphone, the image is stored within a file 626 as part of an image rendering process, which is figuratively indicated by a callout icon 627 of a painter 628. This icon may indicate that a rendering engine or other application at the cloud gaming server may generate a particular frame, which is further shown in this figure, in specific response to the cloud gaming input information transmitted at step 101, and discussed in more detail above. This particular rendering of an image may correspond to a frame that is generated immediately in response, or substantially immediately in response, to the cloud gaming input information. Thus, in response to the user releasing the finger from the touchscreen of the smartphone, as discussed above regarding FIG. 5, the image may include a user prompt 606 indicating to the user “great job” and “perfect,” thereby indicating that the user successfully released the finger at an appropriate time to achieve a desirable goal within the context of the golf-themed cloud gaming experience. Nevertheless, although the image of FIG. 6 may have been created or generated in a regular manner for the golf-themed cloud game application server-side, a system for measuring end-to-end latency may nevertheless request the performance of the matching process to match the specific created frame, as a response, to a particular item of cloud gaming input information, such as the cloud gaming input information discussed above in connection with FIG. 4 and step 101.

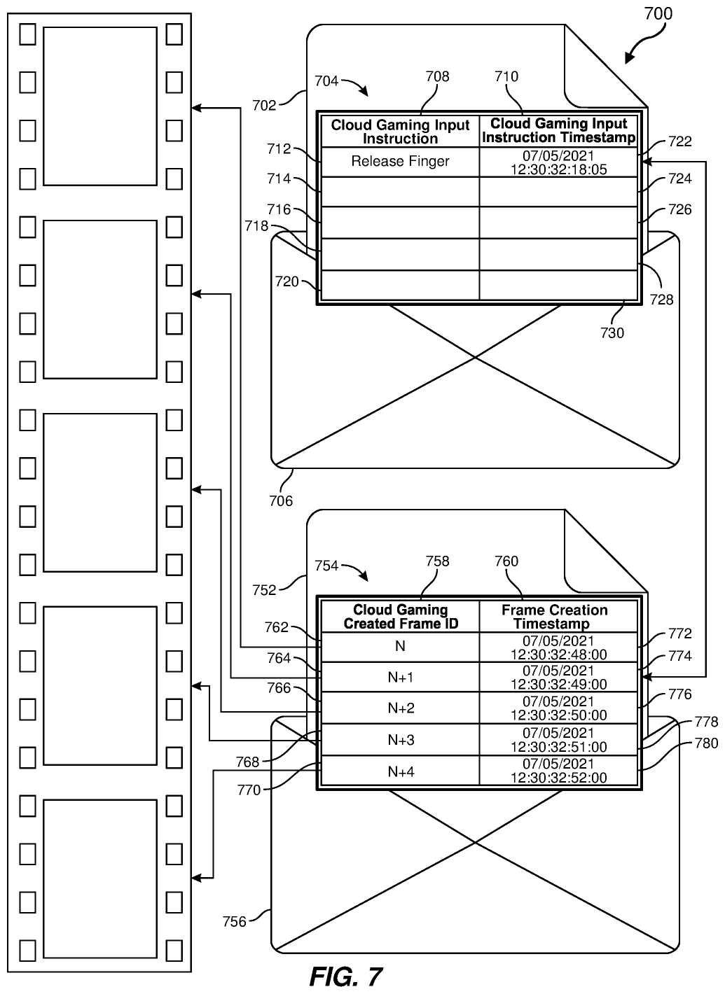

FIG. 7 further shows an illustrative diagram 700 for how server control unit 116 within the cloud gaming server may perform such a matching process to thereby generate a feedback message, as depicted in FIG. 8, which may be transmitted to the cloud gaming client device by feedback sending unit 118 at step 914 of timing diagram 900. As further shown in FIG. 7, server control unit 116 may maintain a local cache 702 with a corresponding table 704, which may be stored within a file format 706, and which may include a column 708 and a column 710. Table 704 may include cells 712-730 for corresponding rows, although, in the illustrative example of this diagram, only the first row may include underlying information, which may correspond to the cloud gaming input information shown in FIG. 4 and transmitted at step 101. This information may have been previously stored by input memory unit 114 at step 910 of timing diagram 900. Input memory unit 114 may also optionally collect or aggregate such rows or items of information in response to receiving a multitude of different network messages containing cloud gaming input information, where the example of FIG. 4 corresponds to just one instance of such a network message.

Server control unit 116 may also monitor, detect, and/or intercept frame creation events, which may correspond to events whereby a corresponding rendering engine renders sequential frames of cloud gaming video. Accordingly, server control unit 116 may optionally be disposed outside of this rendering engine and may further maintain one or more levels of abstraction away from underlying implementation details for how the rendering engine processes user input information and/or generates corresponding frames of video. In the context of FIG. 7, server control unit 116 may also interface with a database 752, which includes a table 754 with a column 758 and a column 760, as well as cells 762-780. These cells may mark frame creation timestamps for corresponding sequential frames of video that are generated in response to user input and/or generated to enable the visual experience at the cloud gaming client device as part of the overall cloud gaming user experience. Moreover, this figure also illustrates how database 752 may be stored within a file format or encapsulation 756.

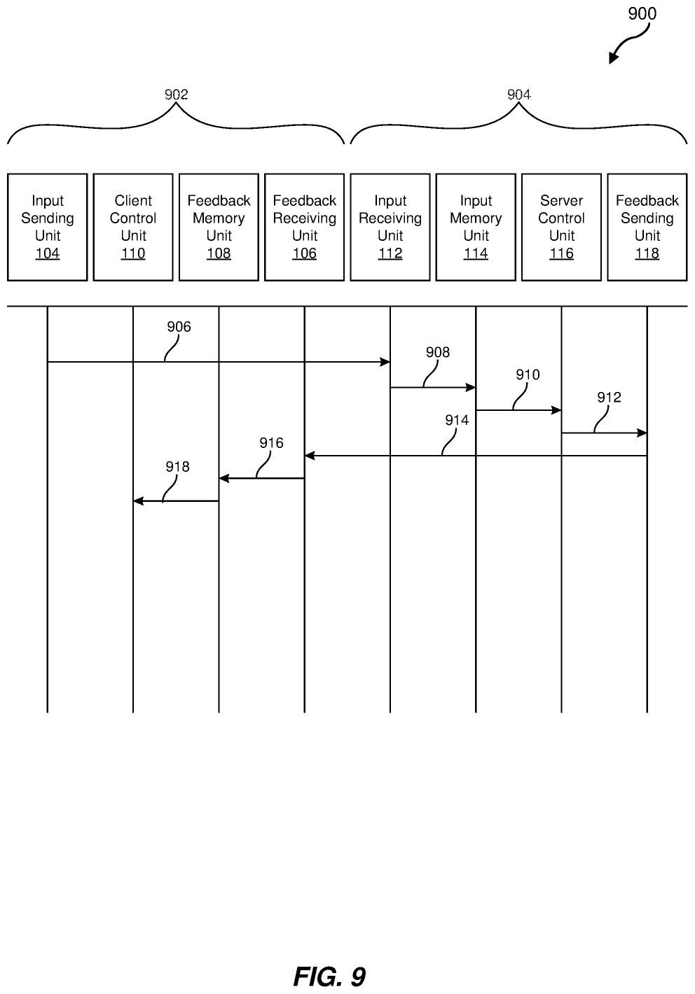

For example, method 100 may also optionally include an input receiving unit at a cloud gaming server receiving the cloud gaming input information. In particular, an input receiving unit 112 within the cloud gaming server may, at a step 908, receive the cloud gaming input information that was transmitted by input sending unit 104 at step 906. This is shown within timing diagram 900 of FIG. 9, including client-side operations 902 and server-side operations 904. Accordingly, server control unit 116 may intercept or detect a frame creation event for creating each of the frames listed within table 754. As one illustrative example, in response to detecting the creation of the frame for cell 764, server control unit 116 may search table 704 to find a matching item of cloud gaming input information.

Server control unit 116 may perform the matching procedure in a variety of ways. In some examples, server control unit 116 may perform the matching procedure based on an expected lag or lapse of time between the corresponding cloud gaming input information timestamp and the frame creation timestamp. Alternatively, with one or more additional subcomponents providing a higher level of intelligence, server control unit 116 may optionally detect that the pixels of the created frame match expected pixels or graphics that would be expected in response to the user input indicated by a corresponding cloud gaming input information message. For example, server control unit 116 may detect a deviation or burst of user input within a larger time period of user input and/or lack of user input, and then match a timing of the deviation or burst to a corresponding deviation or burst in terms of visual output. In other words, server control unit 116 may detect a significant deviation in terms of visual output and match that to a parallel or corresponding deviation in terms of user input just moments earlier. For example, a screen may remain generally static for seconds, and then a user may press a button, and then the screen may significantly change, and server control unit 116 may infer that the pressing of the button triggered the change in the display. Server control unit 116 may additionally, or alternatively, use any other suitable protocol, heuristic, or artificial intelligence component for performing a matching process to match an input timestamp to a frame creation timestamp, as discussed above.

After successfully performing the matching procedure, server control unit 116 may construct a feedback message. FIG. 8 shows a diagram 800 of an illustrative example of such a feedback message 802, which may be stored within a network packet 806 for transmission at step 914 of timing diagram 900. As further shown in FIG. 8, feedback message 802 may include a corresponding table 804 that further includes cells 808-822, which together aggregate the matching information from table 704 and table 754 that are discussed above in connection with FIG. 7. Accordingly, at step 914, feedback sending unit 118 may transmit such a feedback message to feedback receiving unit 106 at the cloud gaming client device, which may receive the feedback message at step 916 of timing diagram 900 and corresponding step 103 of method 100. Moreover, as part of the performance of step 103, feedback receiving unit 106 may also optionally parse the feedback message to identify which input creation timestamp matches which frame creation timestamp.

As illustrated in FIG. 1, at step 105 one or more of the systems described herein may store the frame creation timestamp in memory. For example, feedback memory unit 108 may, at step 105, store the frame creation timestamp from the feedback message in memory, such as memory 140 shown in FIGS. 2-3. An example of memory 140 may correspond to a local cache formed by disk storage or in-memory storage, etc. Furthermore, an illustrative example of such a feedback message is shown in FIG. 8, for example, as discussed at length above.

Returning to FIG. 1, at step 107, one or more of the systems described herein may create a frame render timestamp that marks a timing of an intercepted client-side video frame render event of translating the frame to draw a corresponding frame for a display at the cloud gaming client device. For example, at step 107 of FIG. 1 and corresponding step 918 of FIG. 9, client control unit 110 may create a frame render timestamp that marks a timing of an intercepted client-side video frame render event of translating the frame to draw a corresponding frame for a display at the cloud gaming client device.

Client control unit 110 may perform step 107 and corresponding step 918 in a variety of ways. Generally speaking, client control unit 110 may intercept a client-side video frame render event in a manner that parallels how server control unit 116 intercepted the server-side video frame creation event, as discussed above in connection with FIG. 8. Thus, the performance of step 107 may reflect the fact that two corresponding frames are drawn on the cloud gaming server and the cloud gaming client device, respectively. First, the original frame may be drawn on a virtual display at the cloud gaming server in response to input sending unit 104 sending the cloud gaming input information to the cloud gaming server at step 101. Nevertheless, the virtual display at the cloud gaming server may be relevantly different than a final or target display at the cloud gaming client device. Accordingly, after the original frame is encoded, transmitted to the cloud gaming client device, and decoded to restore the original created frame, further translation operations may be conducted to adapt the original created frame to thereby create a corresponding frame that is appropriately formatted for the display at the cloud gaming client device (i.e., to accommodate any differences between the server-side virtual display and the client-side display). The process of translating at least a portion of the original created frame to create the corresponding frame may be referred to as a client-side video frame render event that renders the corresponding frame using the original created frame as input. Thus, in a manner that parallels how server control unit 116 detects and/or intercepts a timing of the creation of the original frame, client control unit 110 may similarly detect and/or intercept a timing of the translation process to render the corresponding frame that is adapted to the display at the cloud gaming client device. Additionally, or alternatively, rather than intercepting this translation process, client control unit 116 may similarly and simply detect the timing of drawing and/or displaying the corresponding frame at the cloud gaming client device. Moreover, as discussed above, the phrase “intercepting” a specific event in this context may refer to detecting a timing of that specific event. For example, client control unit 110 may create a frame render timestamp that marks a timing of the intercepted client-side video frame render event that is discussed above.

Returning to FIG. 1, at step 109, one or more of the systems described herein may automatically provide feedback to improve a cloud gaming experience through calculating latency by subtracting the input creation timestamp from the frame render timestamp to measure lag between creation of the cloud gaming input information and rendering of the frame at the cloud gaming client device. For example, at step 109, client control unit 110 may automatically provide feedback to improve a cloud gaming experience through calculating latency by subtracting the input creation timestamp from the frame render timestamp to measure lag between creation of the cloud gaming input information and rendering of the frame at the cloud gaming client device.

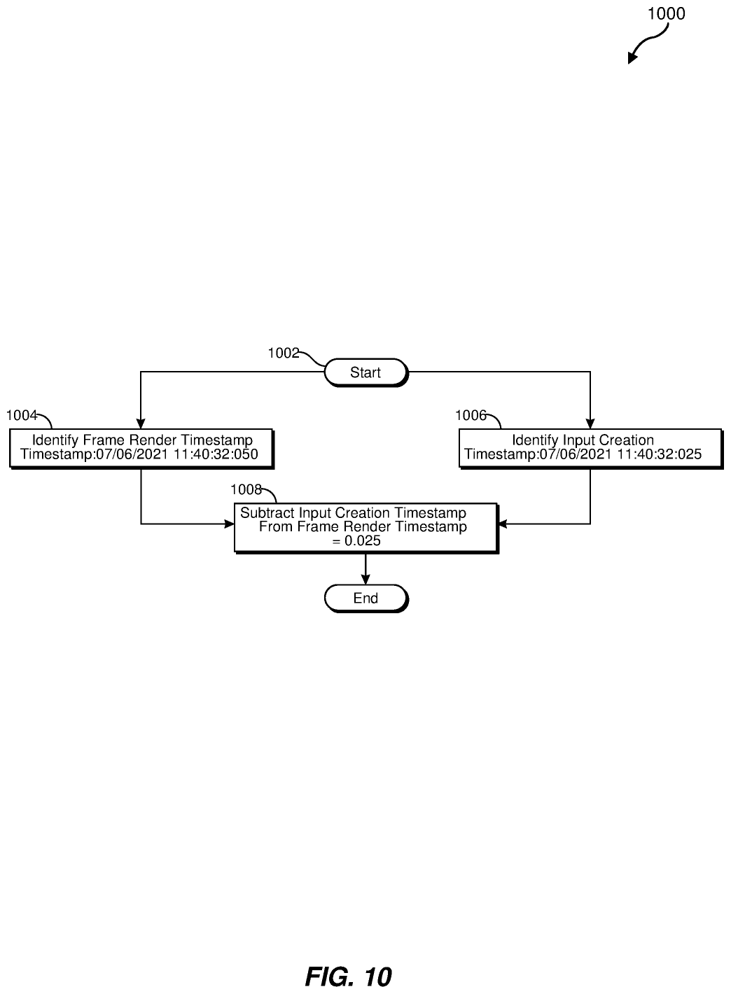

Client control unit 110 may perform step 109 in a variety of ways. FIG. 10 shows a flow diagram for an example method 1000 by which client control unit 110 may calculate latency in accordance with step 109. Method 1000 may begin at a step 1002, and from that point method 1000 may sequentially, or in parallel, perform a step 1004, whereby client control unit 110 may identify a frame render timestamp (as discussed above in connection with step 107), and perform a step 1006, whereby client control unit 110 may identify an input creation timestamp, which may have been provided as part of the feedback message of FIG. 8. Subsequently, at step 1008 of method 1000, client control unit 110 may subtract the input creation timestamp from the frame render timestamp, thereby deriving a precise measurement of end-to-end latency between creation of the cloud gaming input information and client-side rendering of the frame. Client control unit 110 may also additionally, alternatively, or analogously calculate one or more other measurements of lag using any suitable permutation of the cloud gaming input instruction timestamp, the frame creation timestamp, the frame render timestamp, and/or a corresponding client-side frame display timestamp.

Such information may be useful to the client-side cloud gaming application, which might otherwise lack information or insight regarding this specific measurement of latency. In other words, without the performance of method 100, the client-side gaming application may lack insight into the precise details of how much lag is taking place between creation of the cloud gaming input information and client-side rendering of the corresponding frame, as further discussed above.

In addition to performing step 107 to arrive at the measurement of latency, client control unit 110 may also optionally provide the feedback indicating the amount of lag between creation of the cloud gaming input information and rendering of the corresponding frame to a component that is configured to adjust an aspect of the cloud gaming experience. Such a component may be part of the cloud gaming client device, the cloud gaming server, or another device that helps facilitate or manage the overall cloud gaming experience. For example, client control unit 110 may adjust one or more settings in response to a determination that the measurement of latency is higher-than-expected or beyond a predetermined threshold, for example. In these examples, client control unit 110 may optionally make one or more adjustments to compensate for the level of latency. For example, client control unit 110 may increase a prioritization for one or more network packets, may decrease an amount of resolution for a corresponding frame of video, or may prioritize one or more processing threads or computational tasks higher than previously, etc. Generally speaking, client control unit 110 may perform any suitable adjustment to help compensate for an undesirable degree of latency detected through the performance of method 100.

### EXAMPLE EMBODIMENTS

Example 1: An example computer-implemented method may include (i) sending, to a cloud gaming server, cloud gaming input information with an input creation timestamp that marks when the cloud gaming input information was created, (ii) receiving, in response to sending the cloud gaming input information, a frame creation timestamp that marks when a frame was drawn for a virtual display at the cloud gaming server, (iii) storing the frame creation timestamp in memory, (iv) creating a frame render timestamp that marks a timing of an intercepted client-side video frame render event of translating the frame to draw a corresponding frame for a display at a cloud gaming client device, and (v) automatically providing feedback to improve a cloud gaming experience through calculating latency by subtracting the input creation timestamp from the frame render timestamp to measure lag between creation of the cloud gaming input information and rendering of the corresponding frame at the cloud gaming client device.

Example 2: The computer-implemented method of Example 1, where a feedback message that includes the input creation timestamp is sent from the cloud gaming server to the cloud gaming client device.

Example 3: The computer-implemented method of any of Examples 1-2, where subtracting the input creation timestamp from the frame render timestamp is performed by the cloud gaming client device that sent the cloud gaming input information to the cloud gaming server.

Example 4: The computer-implemented method of any of Examples 1-3, where a client control unit at the cloud gaming client device performs subtracting the input creation timestamp from the frame render timestamp.

Example 5: The computer-implemented method of any of Examples 1-4, where the client control unit intercepts the client-side video frame render event for the corresponding frame.

Example 6: The computer-implemented method of any of Examples 1-5, where the client control unit performs subtracting the input creation timestamp from the frame render timestamp in response to intercepting the client-side video frame render event for the corresponding frame.

Example 7: The computer-implemented method of any of Examples 1-6, where the cloud gaming server matches the input creation timestamp with the frame creation timestamp.

Example 8: The computer-implemented method of any of Examples 1-7, where a feedback message that is sent from the cloud gaming server to the cloud gaming client device includes a result of matching the input creation timestamp with the frame creation timestamp.

Example 9: The computer-implemented method of any of Example 1-8, where a feedback receiving unit at the cloud gaming client device parses a feedback message to identify which input creation timestamp matches which frame creation timestamp.

Example 10: The computer-implemented method of any of Examples 1-9, where a client control unit performs subtracting the input creation timestamp from the frame render timestamp in response to a feedback receiving unit receiving a feedback message.

Example 11: The computer-implemented method of any of Examples 1-10, where an amount of lag between creation of the cloud gaming input information and rendering of the corresponding frame at the cloud gaming client device corresponds to an input latency end-to-end measurement for cloud gaming applications.

Example 12: The computer-implemented method of any of Examples 1-11, further including an input receiving unit at a cloud gaming server receiving the cloud gaming input information.

Example 13: The computer-implemented method of any of Examples 1-12, further including an input memory unit at the cloud gaming server storing the cloud gaming input information.

Example 14: The computer-implemented method of any of Examples 1-13, further including a server control unit at the cloud gaming server intercepting a server-side video frame creation event.

Example 15: The computer-implemented method of any of Examples 1-14, further including the server control unit at the cloud gaming server locating, in response to intercepting the server-side video frame creation event, input within a local cache of the cloud gaming server that matches the server-side video frame creation event.

Example 16: The computer-implemented method of any of Examples 1-15, further including a feedback sending unit delivering to a feedback receiving unit a feedback message that indicates a match between the input creation timestamp and the frame creation timestamp that marks when the frame was created in response to the cloud gaming input information.

Example 17: The computer-implemented method of any of Examples 1-16, further including providing feedback indicating an amount of lag between creation of the cloud gaming input information and rendering of the corresponding frame at the cloud gaming client device to a component that is configured to adjust an aspect of the cloud gaming experience.

Example 18: The computer-implemented method of any of Examples 1-17, further including the component adjusting the aspect of the cloud gaming experience based on the feedback indicating the amount of lag between creation of the cloud gaming input information and rendering of the corresponding frame at the cloud gaming client device.

Example 19: A system may include at least one physical processor and a physical memory including computer-executable instructions that, when executed by the physical processor, cause the physical processor to perform a method including (i) sending, to a cloud gaming server, cloud gaming input information with an input creation timestamp that marks when the cloud gaming input information was created, (ii) receiving, in response to sending the cloud gaming input information, a frame creation timestamp that marks when a frame was drawn for a virtual display at the cloud gaming server, (iii) storing the frame creation timestamp in memory, (iv) creating a frame render timestamp that marks a timing of an intercepted client-side video frame render event of translating the frame to draw a corresponding frame for a display at a cloud gaming client device, and (v) automatically providing feedback to improve a cloud gaming experience through calculating latency by subtracting the input creation timestamp from the frame render timestamp to measure lag between creation of the cloud gaming input information and rendering of the corresponding frame at the cloud gaming client device.

Example 20: A non-transitory computer-readable medium including one or more computer-executable instructions that, when executed by at least one processor of a computing device, cause the computing device to (i) send, to a cloud gaming server, cloud gaming input information with an input creation timestamp that marks when the cloud gaming input information was created, (ii) receive, in response to sending the cloud gaming input information, a frame creation timestamp that marks when a frame was drawn for a virtual display at the cloud gaming server, (iii) store the frame creation timestamp in memory, (iv) create a frame render timestamp that marks a timing of an intercepted client-side video frame render event of translating the frame to draw a corresponding frame for a display at a cloud gaming client device, and (v) automatically provide feedback to improve a cloud gaming experience through calculating latency by subtracting the input creation timestamp from the frame render timestamp to measure lag between creation of the cloud gaming input information and rendering of the corresponding frame at the cloud gaming client device.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor,” such as processor 130 in FIG. 2, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
sending, to a cloud gaming server, cloud gaming input information with an input creation timestamp that marks when the cloud gaming input information was created;
receiving, in response to sending the cloud gaming input information, a frame creation timestamp that marks when a frame was drawn for a virtual display at the cloud gaming server;
storing the frame creation timestamp in memory;
creating a frame render timestamp that marks a timing of an intercepted client-side video frame render event of translating the frame to draw a corresponding frame for a display at a cloud gaming client device; and
automatically providing feedback to improve a cloud gaming experience through calculating latency by subtracting the input creation timestamp from the frame render timestamp to measure lag between creation of the cloud gaming input information and rendering of the corresponding frame at the cloud gaming client device.

2. The computer-implemented method of claim 1, wherein a feedback message that includes the input creation timestamp is sent from the cloud gaming server to the cloud gaming client device.

3. The computer-implemented method of claim 1, wherein subtracting the input creation timestamp from the frame render timestamp is performed by the cloud gaming client device that sent the cloud gaming input information to the cloud gaming server.

4. The computer-implemented method of claim 3, wherein a client control unit at the cloud gaming client device performs subtracting the input creation timestamp from the frame render timestamp.

5. The computer-implemented method of claim 4, wherein the client control unit intercepts the client-side video frame render event for the corresponding frame.

6. The computer-implemented method of claim 5, wherein the client control unit performs subtracting the input creation timestamp from the frame render timestamp in response to intercepting the client-side video frame render event for the corresponding frame.

7. The computer-implemented method of claim 1, wherein the cloud gaming server matches the input creation timestamp with the frame creation timestamp.

8. The computer-implemented method of claim 7, wherein a feedback message that is sent from the cloud gaming server to the cloud gaming client device includes a result of matching the input creation timestamp with the frame creation timestamp.

9. The computer-implemented method of claim 1, wherein a feedback receiving unit at the cloud gaming client device parses a feedback message to identify which input creation timestamp matches which frame creation timestamp.

10. The computer-implemented method of claim 1, wherein a client control unit performs subtracting the input creation timestamp from the frame render timestamp in response to a feedback receiving unit receiving a feedback message.

11. The computer-implemented method of claim 1, wherein an amount of lag between creation of the cloud gaming input information and rendering of the corresponding frame at the cloud gaming client device corresponds to an input latency end-to-end measurement for cloud gaming applications.

12. The computer-implemented method of claim 1, further comprising an input receiving unit at a cloud gaming server receiving the cloud gaming input information.

13. The computer-implemented method of claim 12, further comprising an input memory unit at the cloud gaming server storing the cloud gaming input information.

14. The computer-implemented method of claim 13, further comprising a server control unit at the cloud gaming server intercepting a server-side video frame creation event.

15. The computer-implemented method of claim 14, further comprising the server control unit at the cloud gaming server locating, in response to intercepting the server-side video frame creation event, input within a local cache of the cloud gaming server that matches the server-side video frame creation event.

16. The computer-implemented method of claim 15, further comprising a feedback sending unit delivering to a feedback receiving unit a feedback message that indicates a match between the input creation timestamp and the frame creation timestamp that marks when the frame was created in response to the cloud gaming input information.

17. The computer-implemented method of claim 1, further comprising providing feedback indicating an amount of lag between creation of the cloud gaming input information and rendering of the corresponding frame at the cloud gaming client device to a component that is configured to adjust an aspect of the cloud gaming experience.

18. The computer-implemented method of claim 17, further comprising the component adjusting the aspect of the cloud gaming experience based on the feedback indicating the amount of lag between creation of the cloud gaming input information and rendering of the corresponding frame at the cloud gaming client device.

19. A system comprising:
at least one physical processor;
physical memory comprising computer-executable instructions that, when executed by the physical processor, cause the physical processor to perform a method comprising:
sending, to a cloud gaming server, cloud gaming input information with an input creation timestamp that marks when the cloud gaming input information was created;
receiving, in response to sending the cloud gaming input information, a frame creation timestamp that marks when a frame was drawn for a virtual display at the cloud gaming server;
storing the frame creation timestamp in memory;
creating a frame render timestamp that marks a timing of an intercepted client-side video frame render event of translating the frame to draw a corresponding frame for a display at a cloud gaming client device; and
automatically providing feedback to improve a cloud gaming experience through calculating latency by subtracting the input creation timestamp from the frame render timestamp to measure lag between creation of the cloud gaming input information and rendering of the corresponding frame at the cloud gaming client device.

20. A non-transitory computer-readable medium comprising one or more computer-executable instructions that, when executed by at least one processor of a computing device, cause the computing device to:
send, to a cloud gaming server, cloud gaming input information with an input creation timestamp that marks when the cloud gaming input information was created;
receive, in response to sending the cloud gaming input information, a frame creation timestamp that marks when a frame was drawn for a virtual display at the cloud gaming server;
store the frame creation timestamp in memory;
create a frame render timestamp that marks a timing of an intercepted client-side video frame render event of translating the frame to draw a corresponding frame for a display at a cloud gaming client device; and
automatically provide feedback to improve a cloud gaming experience through calculating latency by subtracting the input creation timestamp from the frame render timestamp to measure lag between creation of the cloud gaming input information and rendering of the corresponding frame at the cloud gaming client device.
